(19) United States
(12) Patent Application Publication
(10) Pub. No.: US 2024/0381115 A1
(43) Pub. Date: Nov. 14, 2024

(54) TRANSMISSION CONFIGURATION INDICATION AND BEAM MANAGEMENT FRAMEWORK

(71) Applicant: QUALCOMM Incorporated, San Diego, CA (US)

(72) Inventors: James BECKMAN, La Jolla, CA (US); Jae Ho RYU, San Diego, CA (US); Muhammad Sayed Khairy ABDELGHAFFAR, San Jose, CA (US)

(21) Appl. No.: 18/643,453

(22) Filed: Apr. 23, 2024

Related U.S. Application Data
(60) Provisional application No. 63/501,519, filed on May 11, 2023.

(51) Int. Cl. H04W 16/28; H04B 7/06; H04L 5/00; H04L 5/14; H04W 76/20

(52) U.S. Cl. CPC H04W 16/28; H04B 7/06968; H04L 5/0051; H04L 5/14; H04W 76/20

(57) ABSTRACT

Various aspects of the present disclosure generally relate to wireless communication. In some aspects, a user equipment (UE) may receive signaling associated with a transmission configuration indication (TCI) and beam management (BM) (TCI/BM) framework for sub-band full duplex (SBFD) slots and non-SBFD slots. The UE may apply the TCI/BM framework to communications on one or more of the SBFD slots and the non-SBFD slots. Numerous other aspects are described.

### CROSS-REFERENCE TO RELATED APPLICATION

This Patent application claims priority to U.S. Provisional Patent Application No. 63/501,519, filed on May 11, 2023, entitled “TRANSMISSION CONFIGURATION INDICATION AND BEAM MANAGEMENT FRAMEWORK,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for a transmission configuration indication and beam management framework for sub-band full duplex (SBFD) and non-SBFD slots.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include one or more memories and one or more processors coupled to the one or more memories. The one or more processors may be individually or collectively configured to receive signaling associated with a transmission configuration indication (TCI) and beam management (BM) (TCI/BM) framework for sub-band full duplex (SBFD) slots and non-SBFD slots. The one or more processors may be individually or collectively configured to apply the TCI/BM framework to communications on one or more of the SBFD slots and the non-SBFD slots.

Some aspects described herein relate to a network node for wireless communication. The network node may include one or more memories and one or more processors coupled to the one or more memories. The one or more processors may be individually or collectively configured to transmit signaling associated with a TCI/BM framework for SBFD slots and non-SBFD slots. The one or more processors may be individually or collectively configured to apply the TCI/BM framework to communications on one or more of the SBFD slots and the non-SBFD slots.

Some aspects described herein relate to a method of wireless communication performed by a UE. The method may include receiving signaling associated with a TCI/BM framework for SBFD slots and non-SBFD slots. The method may include applying the TCI/BM framework to communications on one or more of the SBFD slots and the non-SBFD slots.

Some aspects described herein relate to a method of wireless communication performed by a network node. The method may include transmitting signaling associated with a TCI/BM framework for SBFD slots and non-SBFD slots. The method may include applying the TCI/BM framework to communications on one or more of the SBFD slots and the non-SBFD slots.

Some aspects described herein relate to a non-transitory computer-readable medium that stores a set of instructions for wireless communication by a UE. The set of instructions, when executed by one or more processors of the UE, may cause the UE to receive signaling associated with a TCI/BM framework for SBFD slots and non-SBFD slots. The set of instructions, when executed by one or more processors of the UE, may cause the UE to apply the TCI/BM framework to communications on one or more of the SBFD slots and the non-SBFD slots.

Some aspects described herein relate to a non-transitory computer-readable medium that stores a set of instructions for wireless communication by a network node. The set of instructions, when executed by one or more processors of the network node, may cause the network node to transmit signaling associated with a TCI/BM framework for SBFD slots and non-SBFD slots. The set of instructions, when executed by one or more processors of the network node, may cause the network node to apply the TCI/BM framework to communications on one or more of the SBFD slots and the non-SBFD slots.

Some aspects described herein relate to an apparatus for wireless communication. The apparatus may include means for receiving signaling associated with a TCI/BM framework for SBFD slots and non-SBFD slots. The apparatus may include means for applying the TCI/BM framework to communications on one or more of the SBFD slots and the non-SBFD slots.

Some aspects described herein relate to an apparatus for wireless communication. The apparatus may include means for transmitting signaling associated with a TCI/BM framework for SBFD slots and non-SBFD slots. The apparatus may include means for applying the TCI/BM framework to communications on one or more of the SBFD slots and the non-SBFD slots.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals May include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of channel state information reference signal beam management procedures, in accordance with the present disclosure.

FIG. 5 is a diagram illustrating an example of using beams for communications between a network node and a UE, in accordance with the present disclosure.

FIG. 6 is a diagram illustrating an example associated with communication via a transmission configuration indication (TCI) and beam management (BM) (TCI/BM) framework with a common TCI configuration for sub-band full duplex (SBFD) slots and non-SBFD slots, in accordance with the present disclosure.

FIG. 7 is a diagram illustrating an example associated with communication via a TCI/BM framework with different TCI configurations for SBFD slots and non-SBFD slots, in accordance with the present disclosure.

FIG. 8 is a diagram illustrating an example process performed, for example, by a UE, in accordance with the present disclosure.

FIG. 9 is a diagram illustrating an example process performed, for example, by a network node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Sub-band full duplex (SBFD) slots and non-SBFD slots are two types of resource blocks that can be used in 5G wireless communication systems. With SBFD slots, a user equipment (UE) can simultaneously transmit and receive data on the same frequency band, which allows for more efficient use of spectrum resources. However, this requires specific signal processing techniques to mitigate interference between the transmitted and received signals. Non-SBFD slots, on the other hand, use separate frequency bands for uplink and downlink transmissions, which simplifies signal processing but can lead to underutilization of spectrum resources.

When using SBFD and non-SBFD slots for communication between a network node and the UE, the physical location of the antennas involved (e.g., whether or not the antennas are quasi co-located (QCLed)) may impact the quality of the communications on SBFD and/or non-SBFD slots. For example, the UE assuming that the communications during the SBFD slots and non-SBFD slots are on quasi co-located antennas when they are not can result in processing errors. Moreover, assuming the antennas involved are not quasi co-located when they are quasi co-located could lead to increased interference.

Various aspects relate generally to a transmission configuration indication (TCI) and/or beam management (BM) (TCI/BM) framework for SBFD slots and non-SBFD slots. Some aspects more specifically relate to providing a common TCI configuration for the SBFD slots and the non-SBFD slots. Some aspects more specifically relate to providing different TCI configurations for the SBFD slots and the non-SBFD slots. In some examples, a UE may receive signaling associated with a TCI/BM framework for SBFD slots and non-SBFD slots, and apply the TCI/BM framework to communications on one or more of the SBFD slots and the non-SBFD slots. In some examples, a network node may transmit signaling associated with a TCI/BM framework for SBFD slots and non-SBFD slots, and apply the TCI/BM framework to communications on one or more of the SBFD slots and the non-SBFD slots.

Particular aspects of the subject matter described in this disclosure can be implemented to realize one or more of the following potential advantages. In some examples, by having the UE apply the TCI/BM framework, the described techniques can be used to process transmissions during SBFD slots and non-SBFD slots in a way that minimizes interference or other issues that may be caused by the UE assuming that the antennas are quasi co-located (when they are not) or assuming that the antennas are not quasi co-located (when they are). In some examples, by having the network node apply the TCI/BM framework, the described techniques can be used to improve network quality and user experience for the SBFD and the non-SBFD communications with the UE.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

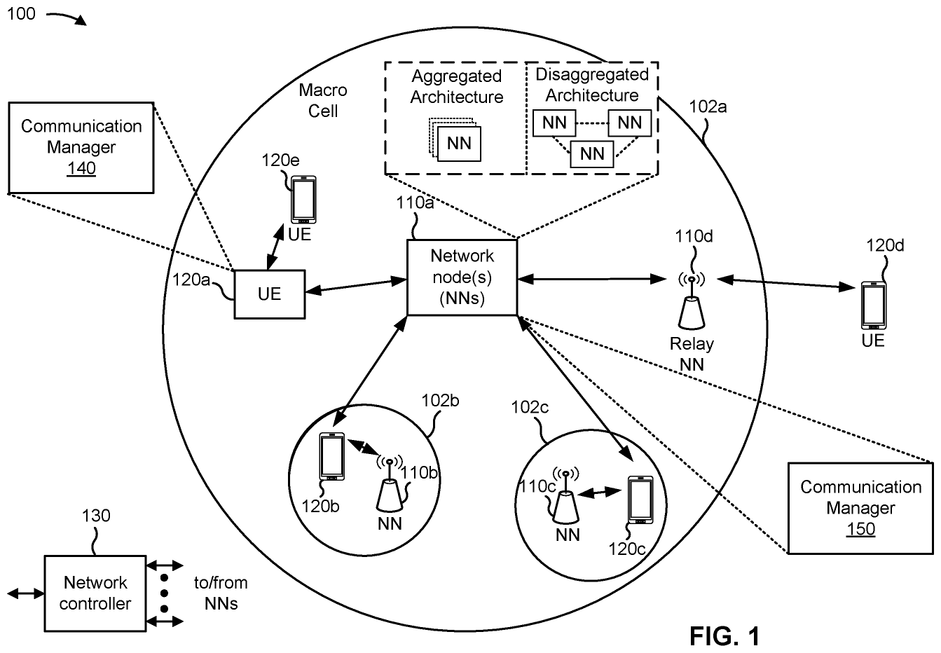

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 May include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive signaling associated with a TCI/BM framework for SBFD slots and non-SBFD slots, and apply the TCI/BM framework to communications on one or more of the SBFD slots and the non-SBFD slots. Additionally, or alternatively, the communication manager 140 may perform one or more other operations described herein.

In some aspects, the network node 110 may include a communication manager 150. As described in more detail elsewhere herein, the communication manager 150 may transmit signaling associated with a TCI/BM framework SBFD slots and non-SBFD slots, and apply the TCI/BM framework to communications on one or more of the SBFD slots and the non-SBFD slots. Additionally, or alternatively, the communication manager 150 may perform one or more other operations described herein.

As indicated above, FIG. 1 is provided as an example. Other examples may differ from what is described with regard to FIG. 1.

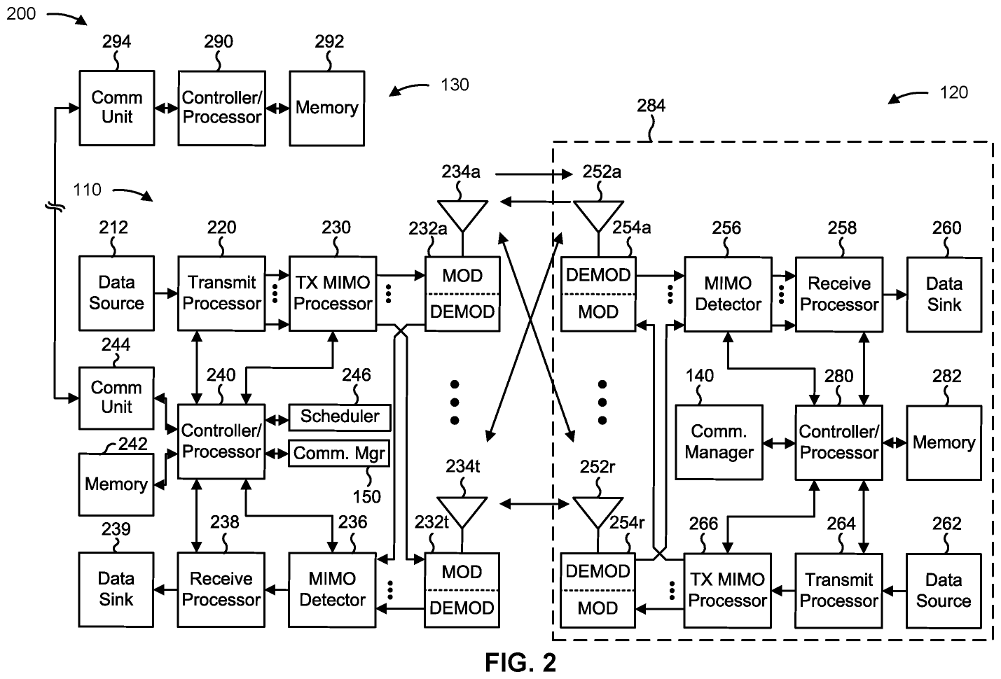

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

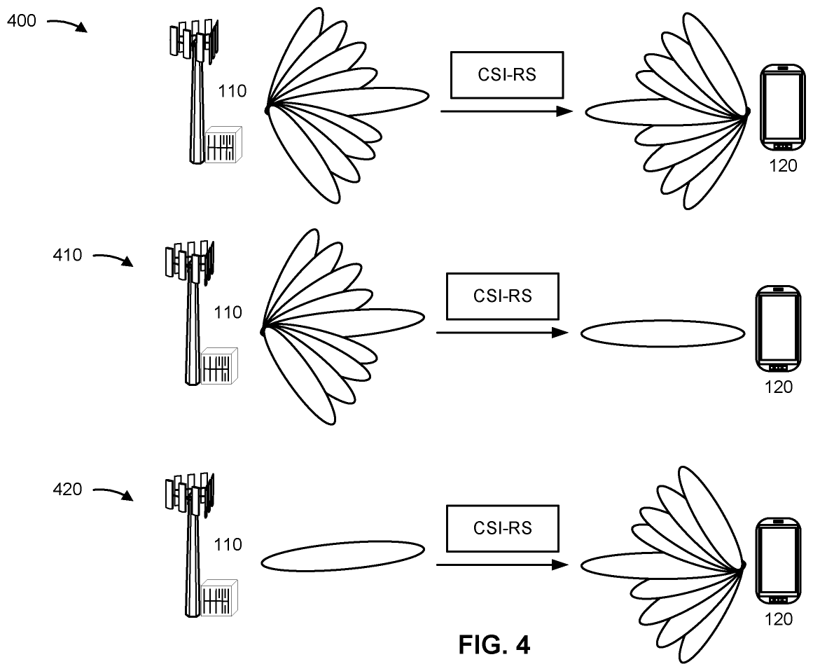

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-11).

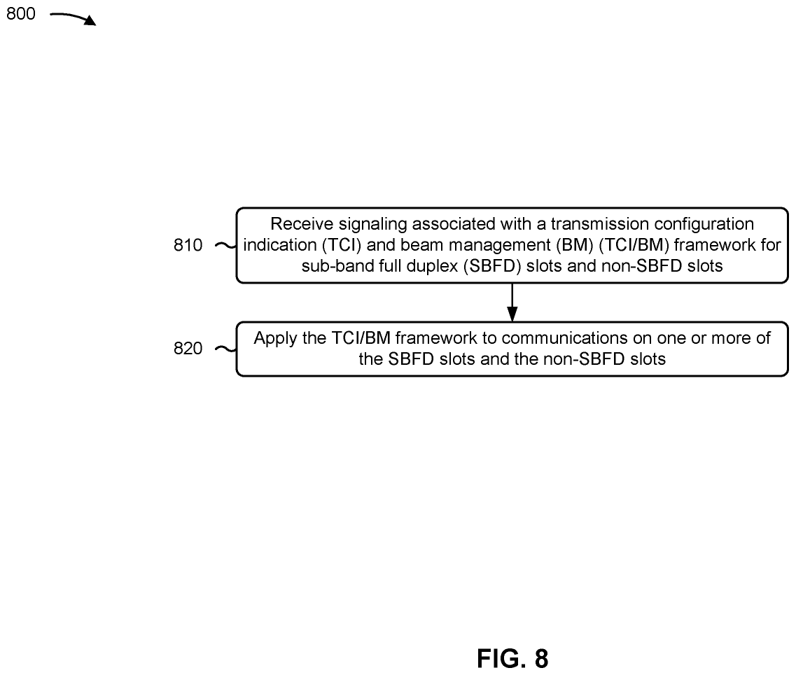

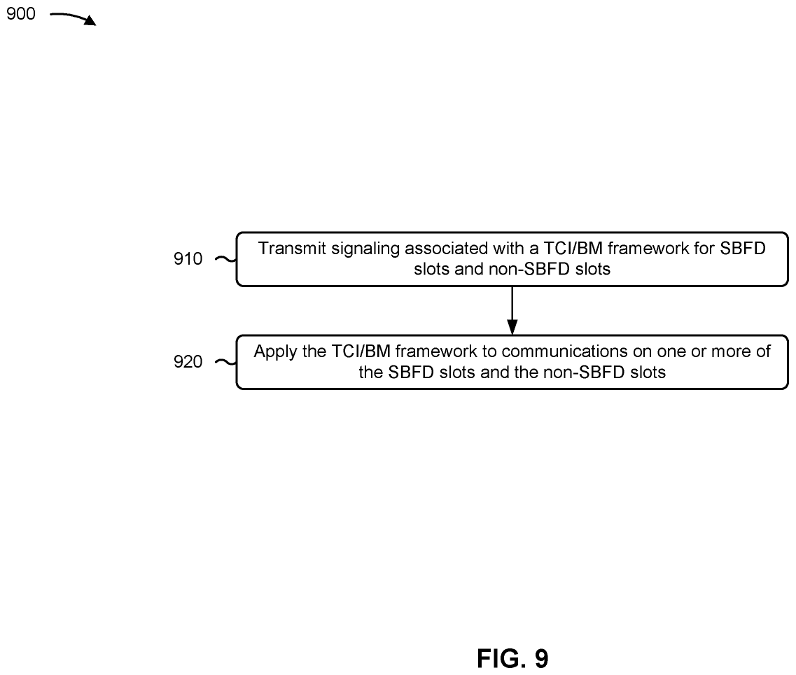

The controller/processor 240 of the network node 110, the controller/processor 280 of the UE 120, and/or any other component(s) of FIG. 2 may perform one or more techniques associated with a TCI/BM framework for SBFD slots and non-SBFD slots, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE 120 includes means for receiving signaling associated with a TCI/BM framework for SBFD slots and non-SBFD slots, and/or means for applying the TCI/BM framework to communications on one or more of the SBFD slots and the non-SBFD slots. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting signaling associated with a TCI/BM framework for SBFD slots and non-SBFD slots, and/or means for applying the TCI/BM framework to communications on one or more of the SBFD slots and the non-SBFD slots. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (CNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

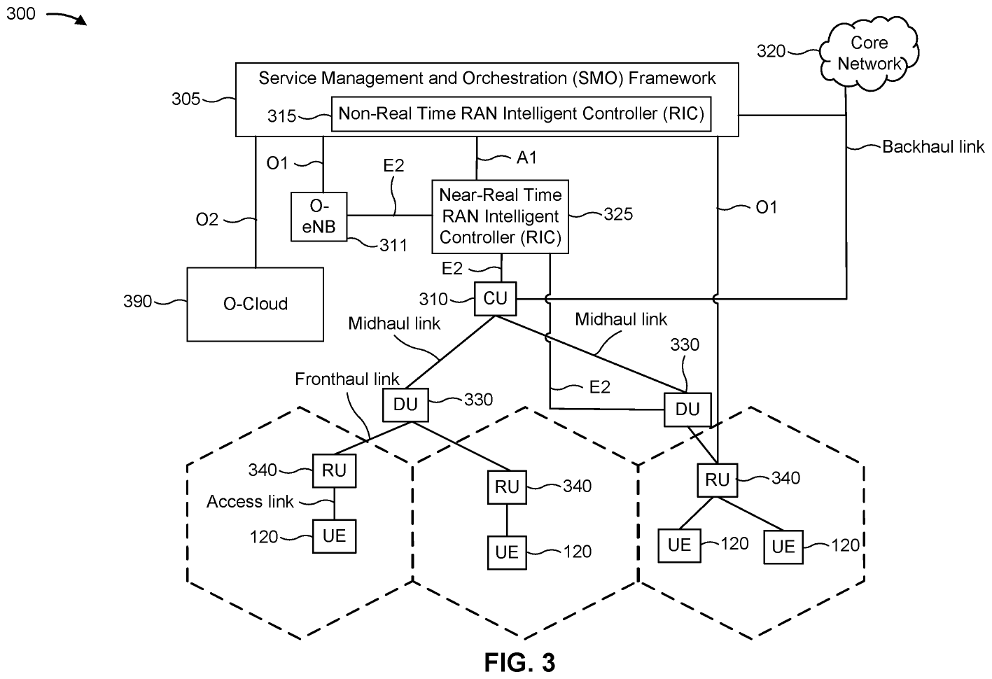

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through FI interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-CNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-cNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating examples 400, 410, and 420 of channel state information reference signal (CSI-RS) beam management procedures, in accordance with the present disclosure. As shown in FIG. 4, examples 400, 410, and 420 include a UE 120 in communication with a network node 110 in a wireless network (e.g., wireless network 100). However, the devices shown in FIG. 4 are provided as examples, and the wireless network may support communication and beam management between other devices (e.g., between a UE 120 and a network node 110 or transmit receive point (TRP), between a mobile termination node and a control node, between an integrated access and backhaul (IAB) child node and an IAB parent node, and/or between a scheduled node and a scheduling node). In some aspects, the UE 120 and the network node 110 may be in a connected state (e.g., an RRC connected state).

As shown in FIG. 4, example 400 may include a network node 110 (e.g., one or more network node devices such as an RU, a DU, and/or a CU, among other examples) and a UE 120 communicating to perform beam management using CSI-RSs. Example 400 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 4 and example 400, CSI-RSs may be configured to be transmitted from the network node 110 to the UE 120. The CSI-RSs may be configured to be periodic (e.g., using RRC signaling), semi-persistent (e.g., using media access control (MAC) control element (MAC-CE) signaling), and/or aperiodic (e.g., using downlink control information (DCI)).

The first beam management procedure may include the network node 110 performing beam sweeping over multiple transmit (Tx) beams. The network node 110 may transmit a CSI-RS using each transmit beam for beam management. To enable the UE 120 to perform receive (Rx) beam sweeping, the network node may use a transmit beam to transmit (e.g., with repetitions) each CSI-RS at multiple times within the same RS resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 400 has been described in connection with CSI-RSs, the first beam management process may also use synchronization signal blocks (SSBs) for beam management in a similar manner as described above.

As shown in FIG. 4, example 410 may include a network node 110 and a UE 120 communicating to perform beam management using CSI-RSs. Example 410 depicts a second beam management procedure (e.g., P2 CSI-RS beam management). The second beam management procedure may be referred to as a beam refinement procedure, a network node beam refinement procedure, a TRP beam refinement procedure, and/or a transmit beam refinement procedure. As shown in FIG. 4 and example 410, CSI-RSs may be configured to be transmitted from the network node 110 to the UE 120. The CSI-RSs may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the network node 110 to select a best transmit beam based at least in part on measurements of the CSI-RSs (e.g., measured by the UE 120 using the single receive beam) reported by the UE 120.

As shown in FIG. 4, example 420 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 4 and example 420, one or more CSI-RSs may be configured to be transmitted from the network node 110 to the UE 120. The CSI-RSs may be configured to be aperiodic (e.g., using DCI). The third beam management process may include the network node 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the network node may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the CSI-RS of the transmit beam using the one or more receive beams).

As indicated above, FIG. 4 is provided as an example of beam management procedures. Other examples of beam management procedures may differ from what is described with respect to FIG. 4. For example, the UE 120 and the network node 110 may perform the third beam management procedure before performing the second beam management procedure, and/or the UE 120 and the network node 110 may perform a similar beam management procedure to select a UE transmit beam.

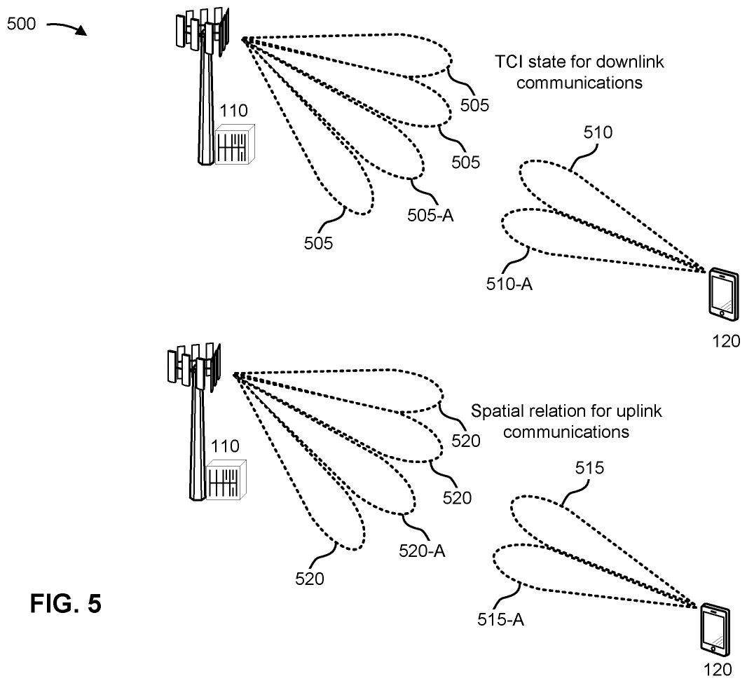

FIG. 5 is a diagram illustrating an example 500 of using beams for communications between a network node and a UE, in accordance with the present disclosure. As shown in FIG. 5, a network node 110 and a UE 120 may communicate with one another.

The network node 110 may transmit to UEs 120 located within a coverage area of the network node 110. The network node 110 and the UE 120 may be configured for beamformed communications, where the network node 110 may transmit in the direction of the UE 120 using a directional NN transmit beam (e.g., a network node transmit beam), and the UE 120 may receive the transmission using a directional UE receive beam. Each NN transmit beam may have an associated beam ID, beam direction, or beam symbols, among other examples. The network node 110 may transmit downlink communications via one or more NN transmit beams 505.

The UE 120 may attempt to receive downlink transmissions via one or more UE receive beams 510, which may be configured using different beamforming parameters at receive circuitry of the UE 120. The UE 120 may identify a particular NN transmit beam 505, shown as NN transmit beam 505-A, and a particular UE receive beam 510, shown as UE receive beam 510-A, that provide relatively favorable performance (for example, that have a best channel quality of the different measured combinations of NN transmit beams 505 and UE receive beams 510). In some examples, the UE 120 may transmit an indication of which NN transmit beam 505 is identified by the UE 120 as a preferred NN transmit beam, which the network node 110 may select for transmissions to the UE 120. The UE 120 may thus attain and maintain a beam pair link (BPL) with the network node 110 for downlink communications (for example, a combination of the NN transmit beam 505-A and the UE receive beam 510-A), which may be further refined and maintained in accordance with one or more established beam refinement procedures.

A downlink beam, such as an NN transmit beam 505 or a UE receive beam 510, may be associated with a transmission configuration indication (TCI) state. A TCI state may indicate a directionality or a characteristic of the downlink beam, such as one or more QCL properties of the downlink beam. A QCL property may include, for example, a Doppler shift, a Doppler spread, an average delay, a delay spread, or spatial receive parameters, among other examples. In some examples, each NN transmit beam 505 may be associated with an SSB, and the UE 120 may indicate a preferred NN transmit beam 505 by transmitting uplink transmissions in resources of the SSB that are associated with the preferred NN transmit beam 505. A particular SSB may have an associated TCI state (for example, for an antenna port or for beamforming). The network node 110 may, in some examples, indicate a downlink NN transmit beam 505 based at least in part on antenna port QCL properties that may be indicated by the TCI state. A TCI state may be associated with one downlink reference signal set (for example, an SSB and an aperiodic, periodic, or semi-persistent channel state information reference signal (CSI-RS)) for different QCL types (for example, QCL types for different combinations of Doppler shift, Doppler spread, average delay, delay spread, or spatial receive parameters, among other examples). In cases where the QCL type indicates spatial receive parameters, the QCL type may correspond to analog receive beamforming parameters of a UE receive beam 510 at the UE 120. Thus, the UE 120 may select a corresponding UE receive beam 510 from a set of BPLs based at least in part on the network node 110 indicating an NN transmit beam 505 via a TCI indication.

The network node 110 may maintain a set of activated TCI states for downlink shared channel transmissions and a set of activated TCI states for downlink control channel transmissions. The set of activated TCI states for downlink shared channel transmissions may correspond to beams that the network node 110 uses for downlink transmission on a physical downlink shared channel (PDSCH). The set of activated TCI states for downlink control channel communications may correspond to beams that the network node 110 may use for downlink transmission on a physical downlink control channel (PDCCH) or in a control resource set (CORESET). The UE 120 may also maintain a set of activated TCI states for receiving the downlink shared channel transmissions and the CORESET transmissions. If a TCI state is activated for the UE 120, then the UE 120 may have one or more antenna configurations based at least in part on the TCI state, and the UE 120 may not need to reconfigure antennas or antenna weighting configurations. In some examples, the set of activated TCI states (for example, activated PDSCH TCI states and activated CORESET TCI states) for the UE 120 may be configured by a configuration message, such as an RRC message.

Similarly, for uplink communications, the UE 120 may transmit in the direction of the network node 110 using a directional UE transmit beam, and the network node 110 may receive the transmission using a directional NN receive beam. Each UE transmit beam may have an associated beam ID, beam direction, or beam symbols, among other examples. The UE 120 may transmit uplink communications via one or more UE transmit beams 515.

The network node 110 may receive uplink transmissions via one or more NN receive beams 520 (e.g., network node receive beams). The network node 110 may identify a particular UE transmit beam 515, shown as UE transmit beam 515-A, and a particular NN receive beam 520, shown as NN receive beam 520-A, that provide relatively favorable performance (for example, that have a best channel quality of the different measured combinations of UE transmit beams 515 and NN receive beams 520). In some examples, the network node 110 may transmit an indication of which UE transmit beam 515 is identified by the network node 110 as a preferred UE transmit beam, which the network node 110 may select for transmissions from the UE 120. The UE 120 and the network node 110 may thus attain and maintain a BPL for uplink communications (for example, a combination of the UE transmit beam 515-A and the NN receive beam 520-A), which may be further refined and maintained in accordance with one or more established beam refinement procedures. An uplink beam, such as a UE transmit beam 515 or an NN receive beam 520, may be associated with a spatial relation. A spatial relation may indicate a directionality or a characteristic of the uplink beam, similar to one or more QCL properties, as described above.

As indicated above, FIG. 5 is provided as an example. Other examples may differ from what is described with respect to FIG. 5.

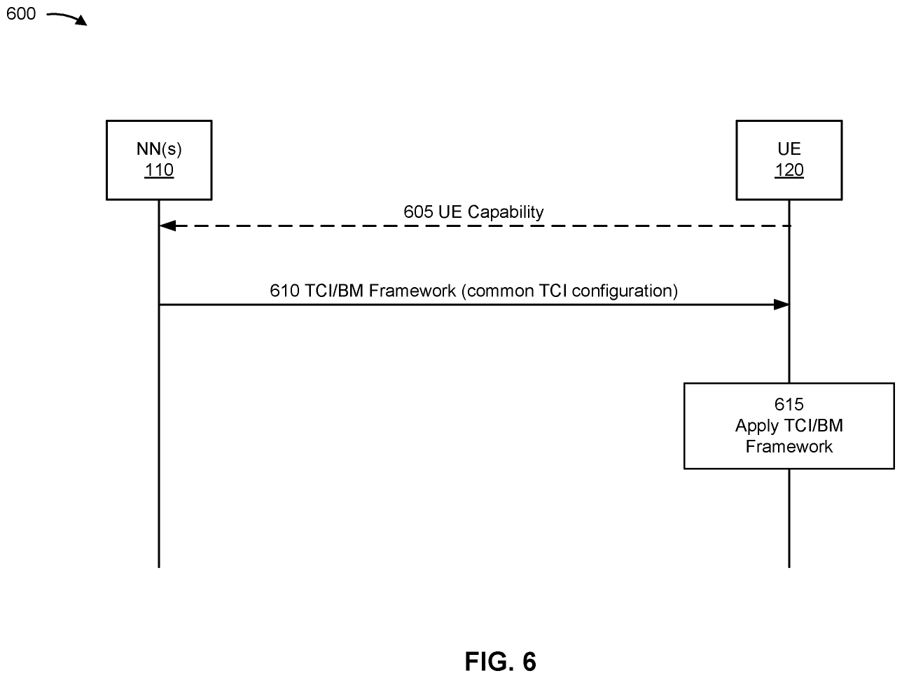

FIG. 6 is a diagram illustrating an example 600 associated with communication via a TCI/BM framework with a common TCI configuration for the SBFD slots and the non-SBFD slots, in accordance with the present disclosure. As shown in FIG. 6, a network node (such as network node 110) and a UE (such as UE 120) may communicate with one another.

As shown by reference number 605, the UE may transmit, and the network node may receive, a UE capability. In some aspects, the UE capability may indicate support for the common TCI configuration. For example, in some aspects, the UE capability may indicate support for a single active TCI state applicable to both SBFD slots and non-SBFD slots. In some aspects, such as if the UE supports only a single active TCI state (for one of, e.g., SBFD slots or non-SBFD slots), the network node may transmit, and the UE may receive, information for another TCI state (for the other of, e.g., SBFD slots or non-SBFD slots) in advance to reduce a switching timeline and/or latency associated with activating the other TCI state.

As shown by reference number 610, the network node may transmit, and the UE may receive, signaling indicating a TCI/BM framework. In some aspects, the signaling associated with the TCI/BM framework may include signaling for a common TCI configuration for the SBFD slots and the non-SBFD slots. The common TCI configuration may be transmitted if, for example, the UE capability indicates that the UE can support the single active TCI state for both SBFD slots and non-SBFD slots, if the antennas for the SBFD slots and the non-SBFD slots are QCLed, and/or a combination thereof, among other examples. In some aspects, the common TCI configuration may include the single active TCI state for the SBFD slots and the non-SBFD slots indicated via the UE capability discussed above with respect to reference number 605. In some aspects, the common TCI configuration may include a set of one or more active TCI states for the SBFD slots and the non-SBFD slots, in which case the one or more active TCI states for the SBFD slots and the non-SBFD slots may be the same. Alternatively, in some aspects, the common TCI configuration may include a first set of one or more active TCI states for the SBFD slots and a second set of one or more active TCI states for the non-SBFD slots. At least one of the one or more active TCI states included in the first set may be the same as at least one of the one or more active TCI states included in the second set. Alternatively, each of the one or more active TCI states included in the first set may be different from each of the one or more active TCI states included in the second set.

In some aspects, the common TCI configuration may be based, at least in part, on a first antenna associated with the SBFD slots and a second antenna associated with the non-SBFD slots being quasi co-located. In some aspects, the common TCI configuration may be indicated via RRC signaling indicating the common TCI configuration across SBFD slots and non-SBFD slots. In some aspects, the common TCI configuration may be implicitly indicated (e.g., the UE may assume that the common TCI configuration will apply to SBFD slots and non-SBFD slots unless indicated otherwise).

In some aspects, the common TCI configuration may include an SSB configuration for the SSB on the non-SBFD slots. In some aspects, the SSB configuration may prohibit the UE from receiving the SSB on the SBFD slots, require the UE to receive the SSB on the non-SBFD slots, and/or a combination thereof, among other examples. In some aspects, the SSB configuration may include a configuration for converting one or more SBFD slots to converted non-SBFD slots. In those aspects, the UE may be configured to receive the SSB on the converted non-SBFD slots.

In some aspects, the common TCI configuration may include a tracking reference signal (TRS) configuration for a TRS on the non-SBFD slots. In some aspects, the TRS configuration may prohibit the UE from receiving the TRS on the SBFD slots, require the UE to receive the TRS on the non-SBFD slots, and/or a combination thereof, among other examples. In some aspects, the TRS configuration may include a configuration for converting one or more SBFD slots to converted non-SBFD slots and receiving the TRS on the converted non-SBFD slots.

As shown by reference number 615, the UE may apply the TCI/BM framework. Applying the TCI/BM framework may include the UE applying the configurations included in the TCI/BM framework to communications on SBFD slots and non-SBFD slots. In some aspects, applying the TCI/BM framework may include preventing conflicts in the SSB and/or TRS patterns. For example, conflicts may be prevented by prohibiting the SSB and/or TRS on SBFD slots. Alternatively, the TCI/BM framework may prioritize SBFD slots in a way that prevents SSB and/or TRS patterns on SBFD slots. Alternatively, the TCI/BM framework may prioritize SSB and/or TRS patterns, in which case the SBFD slots used for SSB and/or TRS patterns may be converted to non-SBFD slots.

By applying the TCI/BM framework, the UE may receive and process signals on SBFD slots and non-SBFD slots without having to assume that the antennas are quasi co-located (when they are not) or assume that the antennas are not quasi co-located (when they are). Doing so can potentially reduce interference and minimize other issues that may be caused by the UE assuming whether or not the antennas are QCLed.

As indicated above, FIG. 6 is provided as an example. Other examples may differ from what is described with respect to FIG. 6.

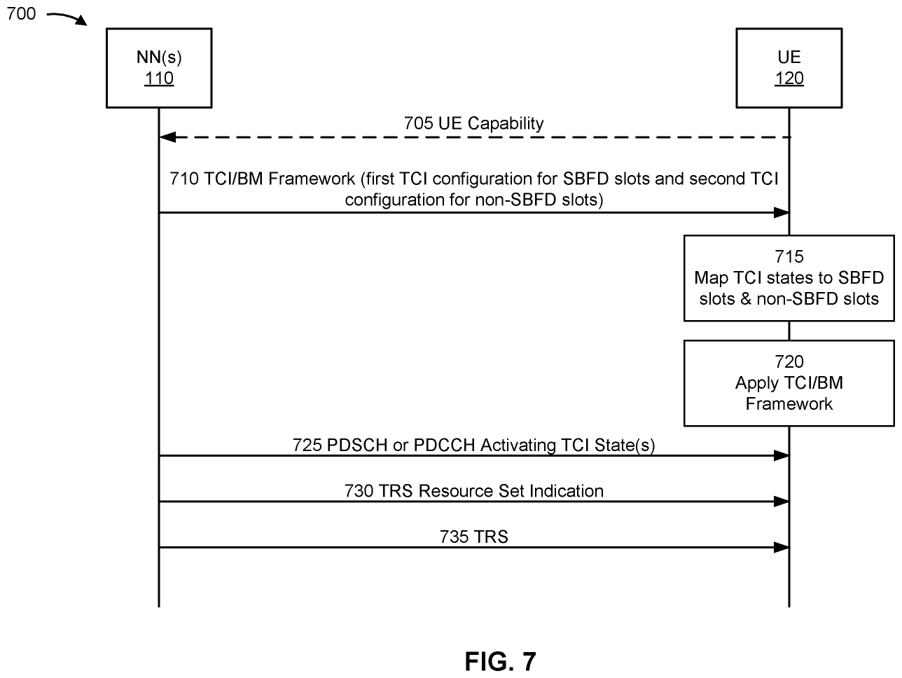

FIG. 7 is a diagram illustrating an example 700 associated with communication via a TCI/BM framework with different TCI configurations for the SBFD slots and the non-SBFD slots, in accordance with the present disclosure. As shown in FIG. 7, a network node 110 and a UE 120 may communicate with one another.

As shown by reference number 705, the UE may transmit, and the network node may receive, a UE capability. In some aspects, the UE capability may indicate support for multiple TCI configurations. For example, in some aspects, the UE capability may indicate support for a first TCI configuration for the SBFD slots and a second TCI configuration for the non-SBFD slots.

As shown by reference number 710, the network node may transmit, and the UE may receive, signaling for a TCI/BM framework. In some aspects, the TCI/BM framework may include the first TCI configuration for the SBFD slots and the second TCI configuration for the non-SBFD slots. In some aspects, the first TCI configuration may be associated with a first antenna having a first QCL property. In some aspects, the second TCI configuration may be associated with a second antenna having a second QCL property different from the first QCL property.

In some aspects, the first TCI configuration, the second TCI configuration, and/or a combination thereof, among other examples, may be transmitted by the network node, and received by the UE, via RRC signaling. For example, the RRC signaling may provide a separate TCI configuration list to, for example, add the separate TCI configuration list to indicate whether every TCI state corresponds to SBFD slots or non-SBFD slots.

In some aspects, the first TCI configuration may be based, at least in part, on MAC-CE signaling that activates a first TCI state for the SBFD slots and a second TCI state for the non-SBFD slots. For example, the MAC-CE signaling may activate the first TCI state and the second TCI state, and possibly more TCI states, for one TCI codepoint. In aspects where two TCI states are activated, the first TCI state may be associated with the SBFD slots and the second TCI state may be associated with the non-SBFD slots. In some aspects, the first TCI configuration may include a first set of one or more active TCI states for the SBFD slots and the second TCI configuration may include a second set of one or more active TCI states for the non-SBFD slots. At least one of the one or more active TCI states included in the first set may be the same as at least one of the one or more active TCI states included in the second set. Alternatively, each of the one or more active TCI states included in the first set may be different from each of the one or more active TCI states included in the second set.

In some aspects, the second TCI configuration may include an SSB configuration, as discussed above with respect to FIG. 6. Alternatively or in addition, in some aspects, the first TCI configuration may include a first tracking reference signal (TRS) resource set and the second TCI configuration may include a second TRS resource set. The first TRS resource set may include resources for a TRS in one or more of the non-SBFD slots. Alternatively or in addition, in some aspects, the first TRS resource set may include resources for the TRS in one or more of the SBFD slots. In some aspects, the first TRS resource set may include resources for the TRS in one or more downlink sub-bands of one or more of the SBFD slots. In some aspects, the first TRS resource set may include resources for the TRS across downlink and uplink sub-bands of one or more of the SBFD slots. In some aspects, the first TCI configuration may configure the TRS in two or more consecutive SBFD slots. In some aspects, the second TCI configuration may configure the TRS in two or more consecutive non-SBFD slots. In some aspects, the first TCI configuration and/or the second TCI configuration may configure the TRS in two or more consecutive slots where one of the consecutive slots is one of the SBFD slots and another of the consecutive slots is one of the non-SBFD slots.

As shown by reference number 715, the UE may map TCI states indicated by the first TCI configuration, the second TCI configuration, and/or a combination thereof, among other examples, to the SBFD slots and non-SBFD slots. For example, using the RRC signaling, the UE may map each of two or more TCI states to either SBFD slots or non-SBFD slots. In some aspects, the UE may use RRC signaling to map a first bandwidth part (BWP) to the SBFD slots in accordance with the first TCI configuration. In some aspects, the UE may use the RRC signaling to map a second BWP to the non-SBFD slots in accordance with the second TCI configuration. In some aspects, the RRC signaling may provide other information that can be used to deterministically map the TCI states between the SBFD slots and the non-SBFD slots.

As shown by reference number 720, the UE may apply the TCI/BM framework. Applying the TCI/BM framework may include the UE applying the configurations included in the TCI/BM framework to communications on SBFD slots and non-SBFD slots. For example, in some aspects, the UE may apply the first TCI configuration to communications on the SBFD slots and the second TCI configuration to communications on the non-SBFD slots.

As shown by reference number 725, the network node may transmit, and the UE may receive, a PDSCH or PDCCH communication activating a first TCI state for the SBFD slots, a second TCI state for the non-SBFD slots, and/or a combination thereof, among other examples.

As shown by reference number 730, the network node may transmit, and the UE may receive, a TRS resource set indication. In some aspects, the TRS resource set indication may indicate, to the UE, that the first TRS resource set includes SBFD symbols. In some aspects, the TRS resource set indication may indicate, to the UE, that the first TRS resource set includes non-SBFD symbols (i.e., the SBFD TRS may be transmitted in non-SBFD slots), in which case the PDSCH may be rate matched around the TRS symbols since the TRS and PDSCH may use different antenna configurations.

As shown by reference number 735, the network node may transmit, and the UE may receive, the TRS. In some aspects, the TRS may be received in accordance with the first TCI configuration, the second TCI configuration, and/or a combination thereof, among other examples. In some aspects, the network node may transmit, and the UE may receive, a first TRS in accordance with one of the first TCI configuration or the second TCI configuration and a second TRS in accordance with another of the first TCI configuration or the second TCI configuration. In some aspects, the network node may transmit, and the UE may receive, a first TRS in accordance with the first TCI configuration and a second TRS in accordance with the second TCI configuration. In some aspects, the transmission of the first TRS may occur between transmissions of the second TRS so as not to conflict with one another.

In some aspects, the first TRS, the second TRS, or both, may be transmitted in one or multiple downlink sub-bands of an SBFD slot. In some aspects, no uplink transmissions may be configured in the uplink sub-band of the SBFD slots when the downlink sub-bands of the SBFD slots are used to transmit the first TRS, the second TRS, or both. Alternatively, the first TRS, the second TRS, or both, may be transmitted across the downlink and uplink sub-bands of an SBFD slot. To reduce switching time between SBFD slots and non-SBFD slots, the TRS symbols transmitted on the downlink sub-band, and symbols in between, may be indicated as non-SBFD symbols.

In some aspects, the TCI configuration associated with the transmission of the TRS may follow a transmission pattern that alternates between the transmission of the TRS according to the first TCI configuration and the second TCI configuration, and the network node may indicate the transmission pattern to the UE.

In some aspects, such as when the UE is configured with the TRS in two consecutive slots, the UE may be configured for TRS on two consecutive slots (or the symbols for TRS included in the two consecutive slots) of the same type (e.g., both SBFD slots or both non-SBFD slots). In some aspects, the UE may be further configured such that the TRS transmissions have the same frequency resources across the two consecutive slots. Alternatively, the UE may be configured for TRS on two consecutive slots of different types (e.g., one of the two consecutive slots is the SBFD slot and another of the two consecutive slots is the non-SBFD slot) in accordance with the UE capability, QCL information from the network node, and an RRC configuration.

By applying the first TCI configuration to SBFD slots and the second TCI configuration to non-SBFD slots, the network node and the UE can improve network quality and user experience involving SBFD slots and non-SBFD slots.

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 120) performs operations associated with a TCI/BM framework for SBFD slots and non-SBFD slots.

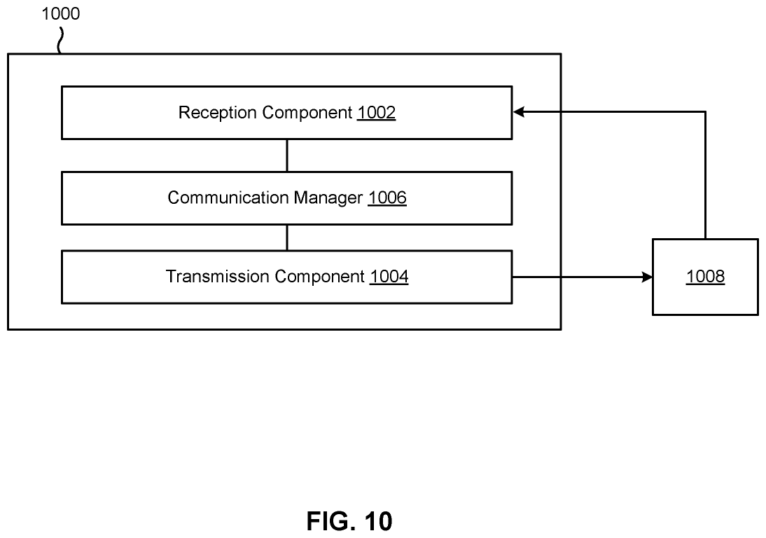

As shown in FIG. 8, in some aspects, process 800 may include receiving signaling associated with a TCI/BM framework for SBFD slots and non-SBFD slots (block 810). For example, the UE (e.g., using reception component 1002 and/or communication manager 1006, depicted in FIG. 10) may receive signaling associated with a TCI/BM framework for SBFD slots and non-SBFD slots, as described above.

As further shown in FIG. 8, in some aspects, process 800 may include applying the TCI/BM framework to communications on one or more of the SBFD slots and the non-SBFD slots (block 820). For example, the UE (e.g., using communication manager 1006, depicted in FIG. 10) may apply the TCI/BM framework to communications on one or more of the SBFD slots and the non-SBFD slots, as described above.

Process 800 may include additional aspects, such as any single aspect or any combination of aspects described below and/or in connection with one or more other processes described elsewhere herein.

In a first aspect, receiving the signaling associated with the TCI/BM framework includes receiving a common TCI configuration for the SBFD slots and the non-SBFD slots.

In a second aspect, alone or in combination with the first aspect, the common TCI configuration is based, at least in part, on a first antenna associated with the SBFD slots and a second antenna associated with the non-SBFD slots being quasi co-located.

In a third aspect, alone or in combination with one or more of the first and second aspects, process 800 includes transmitting a UE capability indicating support for the common TCI configuration.

In a fourth aspect, alone or in combination with one or more of the first through third aspects, the UE capability indicates support for a single active TCI state.

In a fifth aspect, alone or in combination with one or more of the first through fourth aspects, the common TCI configuration includes the single active TCI state for the SBFD slots and the non-SBFD slots.

In a sixth aspect, alone or in combination with one or more of the first through fifth aspects, the common TCI configuration includes a set of one or more active TCI states for the SBFD slots and the non-SBFD slots.

In a seventh aspect, alone or in combination with one or more of the first through sixth aspects, the common TCI configuration includes a first set of one or more active TCI states for the SBFD slots and a second set of one or more active TCI states for the non-SBFD slots.

In an eighth aspect, alone or in combination with one or more of the first through seventh aspects, receiving the common TCI configuration includes receiving the common TCI configuration via radio resource control signaling.

In a ninth aspect, alone or in combination with one or more of the first through eighth aspects, the common TCI configuration includes an SSB configuration for an SSB on the non-SBFD slots.

In a tenth aspect, alone or in combination with one or more of the first through ninth aspects, the SSB configuration prohibits receiving the SSB on the SBFD slots.

In an eleventh aspect, alone or in combination with one or more of the first through tenth aspects, the SSB configuration includes a configuration for converting one or more SBFD slots to converted non-SBFD slots and receiving the SSB on the converted non-SBFD slots.

In a twelfth aspect, alone or in combination with one or more of the first through eleventh aspects, the common TCI configuration includes a TRS configuration for a TRS on the non-SBFD slots.

In a thirteenth aspect, alone or in combination with one or more of the first through twelfth aspects, the TRS configuration prohibits receiving the TRS on the SBFD slots.

In a fourteenth aspect, alone or in combination with one or more of the first through thirteenth aspects, the TRS configuration includes a configuration for converting one or more SBFD slots to converted non-SBFD slots and receiving the TRS on the converted non-SBFD slots.

In a fifteenth aspect, alone or in combination with one or more of the first through fourteenth aspects, receiving the signaling associated with the TCI/BM framework includes receiving a first TCI configuration for the SBFD slots and a second TCI configuration for the non-SBFD slots.

In a sixteenth aspect, alone or in combination with one or more of the first through fifteenth aspects, process 800 includes transmitting a UE capability indicating support for the first TCI configuration and the second TCI configuration.

In a seventeenth aspect, alone or in combination with one or more of the first through sixteenth aspects, the first TCI configuration is associated with a first antenna having a first QCL property, and wherein the second TCI configuration is associated with a second antenna having a second QCL property different from the first QCL property.

In an eighteenth aspect, alone or in combination with one or more of the first through seventeenth aspects, process 800 includes receiving a PDSCH communication or a physical downlink control channel (PDDCH) communication activating one or more of a first TCI state for the SBFD slots or a second TCI state for the non-SBFD slots.

In a nineteenth aspect, alone or in combination with one or more of the first through eighteenth aspects, the first TCI configuration includes a first set of one or more active TCI states for the SBFD slots and the second TCI configuration includes a second set of one or more active TCI states for the non-SBFD slots.

In a twentieth aspect, alone or in combination with one or more of the first through nineteenth aspects, the second TCI configuration includes an SSB configuration.

In a twenty-first aspect, alone or in combination with one or more of the first through twentieth aspects, at least one of the first TCI configuration or the second TCI configuration is received via RRC signaling.

In a twenty-second aspect, alone or in combination with one or more of the first through twenty-first aspects, process 800 includes mapping each of one or more TCI states to one of the SBFD slots or the non-SBFD slots via the RRC signaling.

In a twenty-third aspect, alone or in combination with one or more of the first through twenty-second aspects, the first TCI configuration is based, at least in part, on RRC signaling mapping a first BWP to the SBFD slots and the second TCI configuration is based, at least in part, on the RRC signaling mapping a second BWP to the non-SBFD slots.

In a twenty-fourth aspect, alone or in combination with one or more of the first through twenty-third aspects, the first TCI configuration is based, at least in part, on MAC-CE signaling activating a first TCI state for the SBFD slots and a second TCI state for the non-SBFD slots.

In a twenty-fifth aspect, alone or in combination with one or more of the first through twenty-fourth aspects, the first TCI configuration includes a first TRS resource set and the second TCI configuration includes a second TRS resource set.

In a twenty-sixth aspect, alone or in combination with one or more of the first through twenty-fifth aspects, the first TRS resource set includes resources for a TRS in one or more of the non-SBFD slots.

In a twenty-seventh aspect, alone or in combination with one or more of the first through twenty-sixth aspects, the first TRS resource set includes resources for a TRS in one or more of the SBFD slots.

In a twenty-eighth aspect, alone or in combination with one or more of the first through twenty-seventh aspects, the first TRS resource set includes resources for the TRS in one or more downlink sub-bands of one or more of the SBFD slots.

In a twenty-ninth aspect, alone or in combination with one or more of the first through twenty-eighth aspects, the first TRS resource set includes resources for the TRS across downlink and uplink sub-bands of one or more of the SBFD slots.

In a thirtieth aspect, alone or in combination with one or more of the first through twenty-ninth aspects, process 800 includes receiving a TRS in accordance with the second TCI configuration.

In a thirty-first aspect, alone or in combination with one or more of the first through thirtieth aspects, process 800 includes receiving a first TRS in accordance with one of the first TCI configuration or the second TCI configuration and a second TRS in accordance with another of the first TCI configuration or the second TCI configuration.

In a thirty-second aspect, alone or in combination with one or more of the first through thirty-first aspects, process 800 includes receiving a first TRS in accordance with the first TCI configuration and a second TRS in accordance with the second TCI configuration.

In a thirty-third aspect, alone or in combination with one or more of the first through thirty-second aspects, process 800 includes receiving an indication that the first TRS resource set includes SBFD symbols.

In a thirty-fourth aspect, alone or in combination with one or more of the first through thirty-third aspects, process 800 includes receiving an indication that the first TRS resource set includes non-SBFD symbols.

In a thirty-fifth aspect, alone or in combination with one or more of the first through thirty-fourth aspects, one or more of the first TCI configuration configures a TRS in two or more consecutive SBFD slots or the second TCI configuration configures the TRS in two or more consecutive non-SBFD slots.

In a thirty-sixth aspect, alone or in combination with one or more of the first through thirty-fifth aspects, one or more of the first TCI configuration or the second TCI configuration configures a tracking reference signal in two or more consecutive slots, wherein one of the consecutive slots is one of the SBFD slots and another of the consecutive slots is one of the non-SBFD slots.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node (e.g., network node 110) performs operations associated with a TCI/BM framework for SBFD and non-SBFD slots.

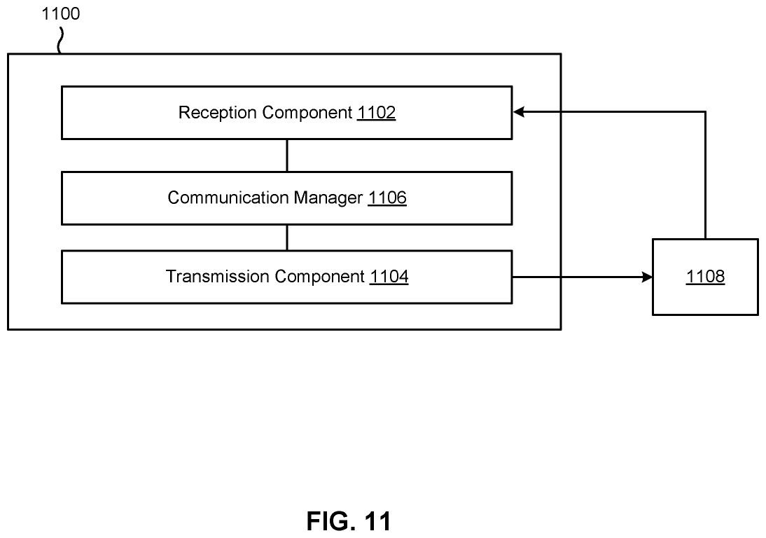

As shown in FIG. 9, in some aspects, process 900 may include transmitting signaling associated with a TCI/BM framework for SBFD slots and non-SBFD slots (block 910). For example, the network node (e.g., using transmission component 1104 and/or communication manager 1106, depicted in FIG. 11) may transmit signaling associated with a TCI/BM framework for SBFD slots and non-SBFD slots, as described above.

As further shown in FIG. 9, in some aspects, process 900 may include applying the TCI/BM framework to communications on one or more of the SBFD slots and the non-SBFD slots (block 920). For example, the network node (e.g., using communication manager 1106, depicted in FIG. 11) may apply the TCI/BM framework to communications on one or more of the SBFD slots and the non-SBFD slots, as described above.

Process 900 may include additional aspects, such as any single aspect or any combination of aspects described below and/or in connection with one or more other processes described elsewhere herein.

In a first aspect, transmitting the signaling associated with the TCI/BM framework includes receiving a common TCI configuration for the SBFD slots and the non-SBFD slots.

In a second aspect, alone or in combination with the first aspect, the common TCI configuration is based, at least in part, on a first antenna associated with the SBFD slots and a second antenna associated with the non-SBFD slots being quasi co-located.

In a third aspect, alone or in combination with one or more of the first and second aspects, process 900 includes receiving a UE capability indicating support for the common TCI configuration.

In a fourth aspect, alone or in combination with one or more of the first through third aspects, the UE capability indicates support for a single active TCI state.

In a fifth aspect, alone or in combination with one or more of the first through fourth aspects, the common TCI configuration includes the single active TCI state for the SBFD slots and the non-SBFD slots.

In a sixth aspect, alone or in combination with one or more of the first through fifth aspects, the common TCI configuration includes a set of one or more active TCI states for the SBFD slots and the non-SBFD slots.

In a seventh aspect, alone or in combination with one or more of the first through sixth aspects, the common TCI configuration includes a first set of one or more active TCI states for the SBFD slots and a second set of one or more active TCI states for the non-SBFD slots.

In an eighth aspect, alone or in combination with one or more of the first through seventh aspects, transmitting the common TCI configuration includes receiving the common TCI configuration via radio resource control signaling.

In a ninth aspect, alone or in combination with one or more of the first through eighth aspects, the common TCI configuration includes a synchronization signal block (SSB) configuration for an SSB on the non-SBFD slots.

In a tenth aspect, alone or in combination with one or more of the first through ninth aspects, the SSB configuration prohibits receiving the SSB on the SBFD slots.

In an eleventh aspect, alone or in combination with one or more of the first through tenth aspects, the SSB configuration includes a configuration for converting one or more SBFD slots to converted non-SBFD slots and receiving the SSB on the converted non-SBFD slots.

In a twelfth aspect, alone or in combination with one or more of the first through eleventh aspects, the common TCI configuration includes a TRS configuration for a TRS on the non-SBFD slots.

In a thirteenth aspect, alone or in combination with one or more of the first through twelfth aspects, the TRS configuration prohibits the TRS on the SBFD slots.

In a fourteenth aspect, alone or in combination with one or more of the first through thirteenth aspects, the TRS configuration includes a configuration for converting one or more SBFD slots to converted non-SBFD slots and receiving the TRS on the converted non-SBFD slots.

In a fifteenth aspect, alone or in combination with one or more of the first through fourteenth aspects, transmitting the signaling associated with the TCI/BM framework includes transmitting a first TCI configuration for the SBFD slots and a second TCI configuration for the non-SBFD slots.

In a sixteenth aspect, alone or in combination with one or more of the first through fifteenth aspects, process 900 includes receiving a UE capability indicating support for the first TCI configuration and the second TCI configuration.

In a seventeenth aspect, alone or in combination with one or more of the first through sixteenth aspects, the first TCI configuration is associated with a first antenna having a first QCL property, and wherein the second TCI configuration is associated with a second antenna having a second QCL property different from the first QCL property.

In an eighteenth aspect, alone or in combination with one or more of the first through seventeenth aspects, process 900 includes transmitting a physical downlink shared channel communication or a physical downlink control channel communication activating one or more of a first TCI state for the SBFD slots or a second TCI state for the non-SBFD slots.

In a nineteenth aspect, alone or in combination with one or more of the first through eighteenth aspects, the first TCI configuration includes a first set of one or more active TCI states for the SBFD slots and the second TCI configuration includes a second set of one or more active TCI states for the non-SBFD slots.

In a twentieth aspect, alone or in combination with one or more of the first through nineteenth aspects, the second TCI configuration includes a synchronization signal block configuration.

In a twenty-first aspect, alone or in combination with one or more of the first through twentieth aspects, at least one of the first TCI configuration or the second TCI configuration is transmitted via RRC signaling.

In a twenty-second aspect, alone or in combination with one or more of the first through twenty-first aspects, process 900 includes mapping each of one or more TCI states to one of the SBFD slots or the non-SBFD slots via the RRC signaling.

In a twenty-third aspect, alone or in combination with one or more of the first through twenty-second aspects, the first TCI configuration is based, at least in part, on RRC signaling mapping a first BWP to the SBFD slots and the second TCI configuration is based, at least in part, on the RRC signaling mapping a second BWP to the non-SBFD slots.

In a twenty-fourth aspect, alone or in combination with one or more of the first through twenty-third aspects, the first TCI configuration is based, at least in part, on MAC-CE signaling activating a first TCI state for the SBFD slots and a second TCI state for the non-SBFD slots.

In a twenty-fifth aspect, alone or in combination with one or more of the first through twenty-fourth aspects, the first TCI configuration includes a first TRS resource set and the second TCI configuration includes a second TRS resource set.

In a twenty-sixth aspect, alone or in combination with one or more of the first through twenty-fifth aspects, the first TRS resource set includes resources for a TRS in one or more of the non-SBFD slots.

In a twenty-seventh aspect, alone or in combination with one or more of the first through twenty-sixth aspects, the first TRS resource set includes resources for a TRS in one or more of the SBFD slots.

In a twenty-eighth aspect, alone or in combination with one or more of the first through twenty-seventh aspects, the first TRS resource set includes resources for the TRS in one or more downlink sub-bands of one or more of the SBFD slots.

In a twenty-ninth aspect, alone or in combination with one or more of the first through twenty-eighth aspects, the first TRS resource set includes resources for the TRS across downlink and uplink sub-bands of one or more of the SBFD slots.

In a thirtieth aspect, alone or in combination with one or more of the first through twenty-ninth aspects, process 900 includes transmitting a TRS in accordance with the second TCI configuration.

In a thirty-first aspect, alone or in combination with one or more of the first through thirtieth aspects, process 900 includes transmitting a first TRS in accordance with one of the first TCI configuration or the second TCI configuration and a second TRS in accordance with another of the first TCI configuration or the second TCI configuration.

In a thirty-second aspect, alone or in combination with one or more of the first through thirty-first aspects, process 900 includes transmitting a first TRS in accordance with the first TCI configuration and a second TRS in accordance with the second TCI configuration.

In a thirty-third aspect, alone or in combination with one or more of the first through thirty-second aspects, process 900 includes transmitting an indication that the first TRS resource set includes SBFD symbols.

In a thirty-fourth aspect, alone or in combination with one or more of the first through thirty-third aspects, process 900 includes transmitting an indication that the first TRS resource set includes non-SBFD symbols.

In a thirty-fifth aspect, alone or in combination with one or more of the first through thirty-fourth aspects, one or more of the first TCI configuration configures a TRS in two or more consecutive SBFD slots or the second TCI configuration configures the TRS in two or more consecutive non-SBFD slots.

In a thirty-sixth aspect, alone or in combination with one or more of the first through thirty-fifth aspects, one or more of the first TCI configuration or the second TCI configuration configures a tracking reference signal in two or more consecutive slots, wherein one of the consecutive slots is one of the SBFD slots and another of the consecutive slots is one of the non-SBFD slots.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 140 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 4-7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive signaling associated with a TCI/BM framework for SBFD slots and non-SBFD slots. The communication manager 1006 may apply the TCI/BM framework to communications on one or more of the SBFD slots and the non-SBFD slots.

The transmission component 1004 may transmit a UE capability indicating support for the common TCI configuration. The transmission component 1004 may transmit a UE capability indicating support for the first TCI configuration and the second TCI configuration.

The reception component 1002 may receive a physical downlink shared channel communication or a physical downlink control channel communication activating one or more of a first TCI state for the SBFD slots or a second TCI state for the non-SBFD slots.

The communication manager 1006 may map each of one or more TCI states to one of the SBFD slots or the non-SBFD slots via the RRC signaling.

The reception component 1002 may receive a TRS in accordance with the second TCI configuration. The reception component 1002 may receive a first TRS in accordance with one of the first TCI configuration or the second TCI configuration, and a second TRS in accordance with another of the first TCI configuration or the second TCI configuration. The reception component 1002 may receive a first TRS in accordance with the first TCI configuration and a second TRS in accordance with the second TCI configuration. The reception component 1002 may receive an indication that the first TRS resource set includes SBFD symbols. The reception component 1002 may receive an indication that the first TRS resource set includes non-SBFD symbols.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 4-7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network node described in connection with FIG. 2. In some aspects, the reception component 1102 and/or the transmission component 1104 may include or may be included in a network interface. The network interface may be configured to obtain and/or output signals for the apparatus 1100 via one or more communications links, such as a backhaul link, a midhaul link, and/or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the network node described in connection with FIG. 2. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The transmission component 1104 may transmit signaling associated with a TCI/BM framework for SBFD slots and non-SBFD slots. The communication manager 1106 may apply the TCI/BM framework to communications on one or more of the SBFD slots and the non-SBFD slots.

The reception component 1102 may receive a UE capability indicating support for the common TCI configuration. The reception component 1102 may receive a UE capability indicating support for the first TCI configuration and the second TCI configuration.

The transmission component 1104 may transmit a physical downlink shared channel communication or a physical downlink control channel communication activating one or more of a first TCI state for the SBFD slots or a second TCI state for the non-SBFD slots.

The communication manager 1106 may map each of one or more TCI states to one of the SBFD slots or the non-SBFD slots via the RRC signaling.

The transmission component 1104 may transmit a TRS in accordance with the second TCI configuration. The transmission component 1104 may transmit a first TRS in accordance with one of the first TCI configuration or the second TCI configuration and a second TRS in accordance with another of the first TCI configuration or the second TCI configuration. The transmission component 1104 may transmit a first TRS in accordance with the first TCI configuration and a second TRS in accordance with the second TCI configuration. The transmission component 1104 may transmit an indication that the first TRS resource set includes SBFD symbols. The transmission component 1104 may transmit an indication that the first TRS resource set includes non-SBFD symbols.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a UE, comprising: receiving signaling associated with a TCI/BM framework for SBFD slots and non-SBFD slots; and applying the TCI/BM framework to communications on one or more of the SBFD slots and the non-SBFD slots.

Aspect 2: The method of Aspect 1, wherein receiving the signaling associated with the TCI/BM framework includes receiving a common TCI configuration for the SBFD slots and the non-SBFD slots.

Aspect 3: The method of Aspect 2, wherein the common TCI configuration is based, at least in part, on a first antenna associated with the SBFD slots and a second antenna associated with the non-SBFD slots being quasi co-located.

Aspect 4: The method of Aspect 2, further comprising transmitting a UE capability indicating support for the common TCI configuration.

Aspect 5: The method of Aspect 4, wherein the UE capability indicates support for a single active TCI state.

Aspect 6: The method of Aspect 5, wherein the common TCI configuration includes the single active TCI state for the SBFD slots and the non-SBFD slots.

Aspect 7: The method of Aspect 2, wherein receiving the common TCI configuration includes receiving the common TCI configuration via radio resource control signaling.

Aspect 8: The method of Aspect 2, wherein the common TCI configuration includes an SSB configuration for an SSB on the non-SBFD slots.

Aspect 9: The method of Aspect 8, wherein the SSB configuration prohibits receiving the SSB on the SBFD slots.

Aspect 10: The method of Aspect 8, wherein the SSB configuration includes a configuration for converting one or more SBFD slots to converted non-SBFD slots and receiving the SSB on the converted non-SBFD slots.

Aspect 11: The method of Aspect 2, wherein the common TCI configuration includes a TRS configuration for a TRS on the non-SBFD slots.

Aspect 12: The method of Aspect 11, wherein the TRS configuration prohibits receiving the TRS on the SBFD slots.

Aspect 13: The method of Aspect 11, wherein the TRS configuration includes a configuration for converting one or more SBFD slots to converted non-SBFD slots and receiving the TRS on the converted non-SBFD slots.

Aspect 14: The method of any of Aspects 1-13, wherein receiving the signaling associated with the TCI/BM framework includes receiving a first TCI configuration for the SBFD slots and a second TCI configuration for the non-SBFD slots.

Aspect 15: The method of Aspect 14, further comprising transmitting a UE capability indicating support for the first TCI configuration and the second TCI configuration.

Aspect 16: The method of Aspect 14, wherein the first TCI configuration is associated with a first antenna having a first QCL property, and wherein the second TCI configuration is associated with a second antenna having a second QCL property different from the first QCL property.

Aspect 17: The method of Aspect 14, further comprising receiving a physical downlink shared channel communication or a physical downlink control channel communication activating one or more of a first TCI state for the SBFD slots or a second TCI state for the non-SBFD slots.

Aspect 18: The method of Aspect 14, wherein the second TCI configuration includes a synchronization signal block configuration.

Aspect 19: The method of Aspect 14, wherein at least one of the first TCI configuration or the second TCI configuration is received via radio resource control (RRC) signaling.

Aspect 20: The method of Aspect 19, further comprising mapping each of one or more TCI states to one of the SBFD slots or the non-SBFD slots via the RRC signaling.

Aspect 21: The method of Aspect 14, wherein the first TCI configuration is based, at least in part, on RRC signaling mapping a first BWP to the SBFD slots and the second TCI configuration is based, at least in part, on the RRC signaling mapping a second BWP to the non-SBFD slots.

Aspect 22: The method of Aspect 14, wherein the first TCI configuration is based, at least in part, on MAC-CE signaling activating a first TCI state for the SBFD slots and a second TCI state for the non-SBFD slots.

Aspect 23: The method of Aspect 14, wherein the first TCI configuration includes a first TRS resource set and the second TCI configuration includes a second TRS resource set.

Aspect 24: The method of Aspect 23, wherein the first TRS resource set includes resources for a TRS in one or more of the non-SBFD slots.

Aspect 25: The method of Aspect 23, wherein the first TRS resource set includes resources for a TRS in one or more of the SBFD slots.

Aspect 26: The method of Aspect 25, wherein the first TRS resource set includes resources for the TRS in one or more downlink sub-bands of one or more of the SBFD slots.

Aspect 27: The method of Aspect 25, wherein the first TRS resource set includes resources for the TRS across downlink and uplink sub-bands of one or more of the SBFD slots.

Aspect 28: The method of Aspect 23, further comprising receiving a TRS in accordance with the second TCI configuration.

Aspect 29: The method of Aspect 23, further comprising receiving a first TRS in accordance with one of the first TCI configuration or the second TCI configuration and a second TRS in accordance with another of the first TCI configuration or the second TCI configuration.

Aspect 30: The method of Aspect 23, further comprising receiving a first TRS in accordance with the first TCI configuration and a second TRS in accordance with the second TCI configuration.

Aspect 31: The method of Aspect 30, further comprising receiving an indication that the first TRS resource set includes SBFD symbols.

Aspect 32: The method of Aspect 30, further comprising receiving an indication that the first TRS resource set includes non-SBFD symbols.

Aspect 33: The method of Aspect 14, wherein one or more of the first TCI configuration configures a TRS in two or more consecutive SBFD slots or the second TCI configuration configures the TRS in two or more consecutive non-SBFD slots.

Aspect 34: The method of Aspect 14, wherein one or more of the first TCI configuration or the second TCI configuration configures a tracking reference signal in two or more consecutive slots, wherein one of the consecutive slots is one of the SBFD slots and another of the consecutive slots is one of the non-SBFD slots.

Aspect 35: A method of wireless communication performed by a network node, comprising: transmitting signaling associated with a TCI/BM framework for SBFD slots and non-SBFD slots; and applying the TCI/BM framework to communications on one or more of the SBFD slots and the non-SBFD slots.

Aspect 36: The method of Aspect 35, wherein transmitting the signaling associated with the TCI/BM framework includes receiving a common TCI configuration for the SBFD slots and the non-SBFD slots.

Aspect 37: The method of Aspect 36, wherein the common TCI configuration is based, at least in part, on a first antenna associated with the SBFD slots and a second antenna associated with the non-SBFD slots being quasi co-located.

Aspect 38: The method of Aspect 36, further comprising receiving a UE capability indicating support for the common TCI configuration.

Aspect 39: The method of Aspect 38, wherein the UE capability indicates support for a single active TCI state.

Aspect 40: The method of Aspect 39, wherein the common TCI configuration includes the single active TCI state for the SBFD slots and the non-SBFD slots.

Aspect 41: The method of Aspect 36, wherein transmitting the common TCI configuration includes receiving the common TCI configuration via radio resource control signaling.

Aspect 42: The method of Aspect 36, wherein the common TCI configuration includes an SSB configuration for an SSB on the non-SBFD slots.

Aspect 43: The method of Aspect 42, wherein the SSB configuration prohibits receiving the SSB on the SBFD slots.

Aspect 44: The method of Aspect 42, wherein the SSB configuration includes a configuration for converting one or more SBFD slots to converted non-SBFD slots and receiving the SSB on the converted non-SBFD slots.

Aspect 45: The method of Aspect 36, wherein the common TCI configuration includes a TRS configuration for a TRS on the non-SBFD slots.

Aspect 46: The method of Aspect 45, wherein the TRS configuration prohibits the TRS on the SBFD slots.

Aspect 47: The method of Aspect 45, wherein the TRS configuration includes a configuration for converting one or more SBFD slots to converted non-SBFD slots and receiving the TRS on the converted non-SBFD slots.

Aspect 48: The method of any of Aspects 35-47, wherein transmitting the signaling associated with the TCI/BM framework includes transmitting a first TCI configuration for the SBFD slots and a second TCI configuration for the non-SBFD slots.

Aspect 49: The method of Aspect 48, further comprising receiving a UE capability indicating support for the first TCI configuration and the second TCI configuration.

Aspect 50: The method of Aspect 48, wherein the first TCI configuration is associated with a first antenna having a first QCL property, and wherein the second TCI configuration is associated with a second antenna having a second QCL property different from the first QCL property.

Aspect 51: The method of Aspect 48, further comprising transmitting a physical downlink shared channel communication or a physical downlink control channel communication activating one or more of a first TCI state for the SBFD slots or a second TCI state for the non-SBFD slots.

Aspect 52: The method of Aspect 48, wherein the second TCI configuration includes a synchronization signal block configuration.

Aspect 53: The method of Aspect 48, wherein at least one of the first TCI configuration or the second TCI configuration is transmitted via RRC signaling.

Aspect 54: The method of Aspect 53, further comprising mapping each of one or more TCI states to one of the SBFD slots or the non-SBFD slots via the RRC signaling.

Aspect 55: The method of Aspect 48, wherein the first TCI configuration is based, at least in part, on RRC signaling mapping a first BWP to the SBFD slots and the second TCI configuration is based, at least in part, on the RRC signaling mapping a second BWP to the non-SBFD slots.

Aspect 56: The method of Aspect 48, wherein the first TCI configuration is based, at least in part, on MAC-CE signaling activating a first TCI state for the SBFD slots and a second TCI state for the non-SBFD slots.

Aspect 57: The method of Aspect 48, wherein the first TCI configuration includes a first TRS resource set and the second TCI configuration includes a second TRS resource set.

Aspect 58: The method of Aspect 57, wherein the first TRS resource set includes resources for a TRS in one or more of the non-SBFD slots.

Aspect 59: The method of Aspect 57, wherein the first TRS resource set includes resources for a TRS in one or more of the SBFD slots.

Aspect 60: The method of Aspect 59, wherein the first TRS resource set includes resources for the TRS in one or more downlink sub-bands of one or more of the SBFD slots.

Aspect 61: The method of Aspect 59, wherein the first TRS resource set includes resources for the TRS across downlink and uplink sub-bands of one or more of the SBFD slots.

Aspect 62: The method of Aspect 57, further comprising transmitting a TRS in accordance with the second TCI configuration.

Aspect 63: The method of Aspect 57, further comprising transmitting a first TRS in accordance with one of the first TCI configuration or the second TCI configuration and a second TRS in accordance with another of the first TCI configuration or the second TCI configuration.

Aspect 64: The method of Aspect 57, further comprising transmitting a first TRS in accordance with the first TCI configuration and a second TRS in accordance with the second TCI configuration.

Aspect 65: The method of Aspect 64, further comprising transmitting an indication that the first TRS resource set includes SBFD symbols.

Aspect 66: The method of Aspect 64, further comprising transmitting an indication that the first TRS resource set includes non-SBFD symbols.

Aspect 67: The method of Aspect 48, wherein one or more of the first TCI configuration configures a tracking reference signal (TRS) in two or more consecutive SBFD slots or the second TCI configuration configures the TRS in two or more consecutive non-SBFD slots.

Aspect 68: The method of Aspect 48, wherein one or more of the first TCI configuration or the second TCI configuration configures a tracking reference signal in two or more consecutive slots, wherein one of the consecutive slots is one of the SBFD slots and another of the consecutive slots is one of the non-SBFD slots.

Aspect 69: An apparatus for wireless communication at a device, comprising a processor; memory coupled with the processor; and instructions stored in the memory and executable by the processor to cause the apparatus to perform the method of one or more of Aspects 1-68.

Aspect 70: A device for wireless communication, comprising a memory and one or more processors coupled to the memory, the one or more processors individually or collectively configured to perform the method of one or more of Aspects 1-68.

Aspect 71: An apparatus for wireless communication, comprising at least one means for performing the method of one or more of Aspects 1-68.

Aspect 72: A non-transitory computer-readable medium storing code for wireless communication, the code comprising instructions executable by a processor to perform the method of one or more of Aspects 1-68.

Aspect 73: A non-transitory computer-readable medium storing a set of instructions for wireless communication, the set of instructions comprising one or more instructions that, when executed by one or more processors of a device, cause the device to perform the method of one or more of Aspects 1-68.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors, coupled to the one or more memories, individually or collectively configured to:
receive signaling associated with a transmission configuration indication (TCI) and beam management (BM) (TCI/BM) framework for sub-band full duplex (SBFD) slots and non-SBFD slots; and
apply the TCI/BM framework to communications on one or more of the SBFD slots and the non-SBFD slots.

2. The UE of claim 1, wherein the one or more processors, to receive the signaling associated with the TCI/BM framework, are individually or collectively configured to receive a common TCI configuration for the SBFD slots and the non-SBFD slots.

3. The UE of claim 2, wherein the one or more processors are further individually or collectively configured to transmit a UE capability indicating support for the common TCI configuration.

4. The UE of claim 1, wherein the one or more processors, to receive the signaling associated with the TCI/BM framework, are individually or collectively configured to receive a first TCI configuration for the SBFD slots and a second TCI configuration for the non-SBFD slots.

5. The UE of claim 4, wherein the one or more processors are further individually or collectively configured to transmit a UE capability indicating support for the first TCI configuration and the second TCI configuration.

6. The UE of claim 4, wherein the first TCI configuration is associated with a first antenna having a first quasi co-location (QCL) property, and wherein the second TCI configuration is associated with a second antenna having a second QCL property different from the first QCL property.

7. The UE of claim 4, wherein the one or more processors are further individually or collectively configured to receive a physical downlink shared channel communication or a physical downlink control channel communication activating one or more of a first TCI state for the SBFD slots or a second TCI state for the non-SBFD slots.

8. The UE of claim 4, wherein the first TCI configuration includes a first set of one or more active TCI states for the SBFD slots and the second TCI configuration includes a second set of one or more active TCI states for the non-SBFD slots.

9. The UE of claim 4, wherein the second TCI configuration includes a synchronization signal block configuration.

10. The UE of claim 4, wherein at least one of the first TCI configuration or the second TCI configuration is received via radio resource control (RRC) signaling.

11. The UE of claim 4, wherein the first TCI configuration is based, at least in part, on radio resource control (RRC) signaling mapping a first bandwidth part (BWP) to the SBFD slots and the second TCI configuration is based, at least in part, on the RRC signaling mapping a second BWP to the non-SBFD slots.

12. The UE of claim 4, wherein the first TCI configuration is based, at least in part, on medium access control (MAC) control element (MAC-CE) signaling activating a first TCI state for the SBFD slots and a second TCI state for the non-SBFD slots.

13. The UE of claim 4, wherein the first TCI configuration includes a first tracking reference signal (TRS) resource set and the second TCI configuration includes a second TRS resource set.

14. The UE of claim 4, wherein one or more of the first TCI configuration configures a tracking reference signal (TRS) in two or more consecutive SBFD slots or the second TCI configuration configures the TRS in two or more consecutive non-SBFD slots.

15. The UE of claim 4, wherein one or more of the first TCI configuration or the second TCI configuration configures a tracking reference signal in two or more consecutive slots, wherein one of the consecutive slots is one of the SBFD slots and another of the consecutive slots is one of the non-SBFD slots.

16. A network node for wireless communication, comprising:
one or more memories; and
one or more processors, coupled to the one or more memories, individually or collectively configured to:
transmit signaling associated with a transmission configuration indication (TCI) and beam management (BM) (TCI/BM) framework for sub-band full duplex (SBFD) slots and non-SBFD slots; and
apply the TCI/BM framework to communications on one or more of the SBFD slots and the non-SBFD slots.

17. The network node of claim 16, wherein the one or more processors, to transmit the signaling associated with the TCI/BM framework, are individually or collectively configured to receive a common TCI configuration for the SBFD slots and the non-SBFD slots.

18. The network node of claim 16, wherein the one or more processors, to transmit the signaling associated with the TCI/BM framework, are individually or collectively configured to transmit a first TCI configuration for the SBFD slots and a second TCI configuration for the non-SBFD slots.

19. A method of wireless communication performed by a user equipment (UE), comprising:
receiving signaling associated with a transmission configuration indication (TCI) and beam management (BM) (TCI/BM) framework for sub-band full duplex (SBFD) slots and non-SBFD slots; and
applying the TCI/BM framework to communications on one or more of the SBFD slots and the non-SBFD slots.

20. The method of claim 19, wherein receiving the signaling associated with the TCI/BM framework includes receiving a first TCI configuration for the SBFD slots and a second TCI configuration for the non-SBFD slots.
